(19) United States
(12) Patent Application Publication
(10) Pub. No.: US 2010/0291338 A1
(43) Pub. Date: Nov. 18, 2010

(54) High-Resolution Optical Information Storage Medium

(75) Inventors: Bérangère Hyot, Eybens (FR); Ludovic Poupinet, Sassenage (FR); Bernard Andre, Quaix En Chartreuse (FR); Patrick Chaton, Theys (FR)

Correspondence Address: LARIVIERE, GRUBMAN & PAYNE, LLP, 19 UPPER RAGSDALE DRIVE, SUITE 200, MONTEREY, CA, 93940, US

(73) Assignee: Commissariat A L'Energie Atomique, Paris (FR)

(21) Appl. No.: 12/526,036

(22) PCT Filed: Feb. 5, 2008
(86) PCT No.: PCT/EP2008/051389

§ 371 Date: Nov. 23, 2009

(30) Foreign Application Priority Data
Feb. 9, 2007 (FR) 07 00938

(51) Int. Cl. B32B 3/02

(52) U.S. Cl. 428/64.7; 428/64.4

(57) ABSTRACT

The invention relates to optical information storage.

According to the invention, what is provided is a high-resolution optical information storage structure, comprising a substrate (10) provided with physical marks, the geometric configuration of which defines the information recorded, a superposition of three layers over the top of the marks on the substrate, and a transparent protective layer over the top of this superposition, the superposition comprising an indium antimonide or gallium antimonide layer (14) inserted between two ZnS/SiO₂ dielectric layers (12, 16).

The information may be prerecorded in the substrate with a resolution (in terms of size and space) better than the theoretical read resolution permitted by the wavelength of the read laser. The non-linearity in behaviour of the three-layer superposition allows the information to be read if the laser power is well chosen.

### PRIORITY CLAIM

This application claims priority to PCT Application Number PCT/EP2008/051389, entitled High-Resolution Optical Information Storage Medium, filed on Feb. 5, 2008 and French Application Number 00938, entitled High-Resolution Optical Information Storage Medium, filed Feb. 9, 2007.

### FIELD OF THE INVENTION

The invention relates to the field of optical information recording.

### BACKGROUND OF THE INVENTION

When it is sought to increase the density of information recorded on an optical disc, this objective is generally limited by the performance of the information read device. The basic principle is that physical information written onto the disc cannot be read very easily if its size is smaller than the limit of resolution of the optical system used to read this information. Typically, when reading with a red laser of 650 nm wavelength and a numerical aperture of 0.6, there is normally no hope of correctly reading information with a size of less than 0.4 microns, or at the limit 0.3 microns.

However, so-called super-resolution methods have been devised for reading information, the physical size of which is smaller, or even much smaller, than the wavelength. These methods are based on the non-linear optical properties of certain materials. The expression “non-linear properties” is understood to mean the fact that certain optical properties of the material change with the intensity of the light that it receives. Usually, the direct cause of this change is the thermal heating due to this illumination: it is the read laser itself that will locally modify the optical properties of the material by thermal, optical, thermo-optic and/or optoelectronic effects over smaller dimensions than the dimension of the read laser spot. Because of the change in property, optical information present in this very small volume becomes detectable, whereas it would not have been detectable without this change.

The phenomenon exploited is principally based on two properties of the read laser that will be used:
firstly, the laser is very strongly focused so as to have an extremely small cross section (of the order of the wavelength), but the power distribution of which is Gaussian, being very strong at its centre but highly attenuated on the periphery; and
secondly, a read laser power is chosen such that the power density over a small part of the cross section, at the centre of the beam, significantly modifies an optical property of the layer, whereas the power density outside this small portion of the cross section does not significantly modify this optical property; the optical property is modified in a direction tending to allow reading of information that would not be able to be read without this modification.

For example, the change in optical property is an increase in the optical transmission in the case in which the reading of a bit consisting of a physical mark formed on the optical disc requires transmission of the laser beam right to this physical mark. The non-linear layer is thus interposed in the path of the beam towards the physical mark. The centre of the laser beam can pass through the layer as far as the mark because as the light passes through the layer the intensity of the incident light makes said layer more transparent, whereas the periphery of the beam will not pass through as it does not modify the optical indices of the layer sufficiently to make it more transparent. It is therefore as if a beam focused down through a much narrower diameter than that permitted by its wavelength had been used.

Various theoretical proposals have been formulated to exploit these principles, but none has given rise to an industrial development. U.S. Pat. No. 5,153,873 recalls the theory. U.S. Pat. No. 5,381,391 gives an example of a film having non-linear reflectivity properties. U.S. Pat. No. 5,569,517 proposes various materials undergoing a crystalline-phase change.

Among the techniques currently offering the greatest options, is the use of a platinum oxide (PtOₓ) layer sandwiched between two layers of a zinc sulphide/silicon oxide compound, the whole assembly being inserted between two layers of an AgInSbTe or GeSbTe compound and this assembly again being inserted between layers of zinc sulphide/silicon oxide compound. The AgInSbTe or GeSbTe material has properties involving a phase change under the effect of intense laser illumination. Examples may be found in Applied Physics Letters Vol. 83, No. 9, September 2003 by Jooho Kim et al., “Super-Resolution by elliptical bubble formation with PtOₓ and AgInSbTe layers” and in Japanese Journal of Applied Physics Vol. 43, No. 7B, 2004, by Jooho Kim et al. “Signal Characteristics of Super-Resolution Near-Field Structure Disc in Blue Laser System”, and in the same journal, by Duseop Yoon et al., “Super-Resolution Read-Only Memory Disc Using Super-Resolution Near-Field Structure Technology”.

The structures described in these articles mainly rely mainly on the creation of platinum oxide expansion bubbles that are confined between the layers that sandwich them. These bubbles are formed during laser writing and can be recognized during read-out, even with a read laser of wavelength equal to several times the size of the bubbles.

However, these bubbles are difficult to produce and it is particularly difficult to control the volume of the bubbles. It is also particularly difficult to adjust the laser power so as to obtain a super-resolution effect at read-out: too low a laser power gives no result and too high a laser power considerably reduces the possible number of read cycles.

### SUMMARY OF THE INVENTION

The invention proposes a much simpler structure, which is easier to implement, requires reasonable read laser power levels and able to undergo many read cycles without the read signal being substantially degraded. The structure according to the invention relies directly on the non-linear properties of certain materials without it being necessary to subject them to a bubble expansion regime that is too difficult to control.

The invention provides a high-resolution optical information storage structure, comprising a substrate provided with physical marks, the geometric configuration of which defines the information recorded, a superposition of three layers over the top of the marks on the substrate, and a transparent protective layer over the top of this superposition, the superposition comprising an indium antimonide or gallium antimonide layer inserted between two dielectric layers of a zinc sulphide/silicon oxide (ZnS/SiO₂) compound.

It has been found that the presence of the ZnS/SiO₂ layers around this antimonide layer makes it possible for the read laser power needed to read the information in super-resolution mode with a satisfactory signal/noise ratio to be considerably reduced. Now, the question of the read power is critical since, on the one hand, a relatively high power is needed to obtain a super-resolution effect by a localized change in optical properties, but on the other hand, a high power tends to gradually destroy the recorded information, limiting the possible number of read cycles, whereas it is desirable to have as high a possible number of read cycles.

Preferably, the substrate is made of polycarbonate, a plastic or polymer.

The atomic proportion of antimony in the compound is 45% to 55%, the indium or gallium proportion being between 45% and the balance to 100% being the antimony proportion. An In₅₀Sb₅₀ or Ga₅₀Sb₅₀ stoichiometric compound is very suitable, but small departures from stoichiometry are acceptable.

The thickness of the InSb or GaSb layer is preferably about 10 to 50 nanometres and optimally between 20 to 30 nanometres.

The ZnS/SiO₂ dielectric layers each preferably have a thickness of between 20 and 100 nanometres, and optimally between 50 and 70 nanometres. The atomic proportion of ZnS and SiO₂ is preferably chosen in the range between ZnS_{85at %/SiO}_{2 15at %} (85/15 proportion) and ZnS_{70at %}/SiO_{2 30at %} (70/30 proportion).

The invention is particularly applicable for reading information using a blue laser, typically with a wavelength of about 400 nanometres, the prerecorded information on the optical disc then being able to have a size (width and length) of 100 nanometres or less, that is to say four to five times smaller than the read wavelength. However, the invention is also applicable for reading using a red laser (wavelength from 600 to 800 nanometres), this being very beneficial as it allows compatibility with conventional optical disc readers of standard resolution—the same red-laser reader may read discs bearing information of standard resolution and discs bearing information in super-resolution form. In this case, the physical marks recorded on the substrate of the optical disc may have a size (length and width) of 200 nanometres or less.

### BRIEF DESCRIPTION OF THE DRAWINGS

Other features and advantages of the invention will become apparent on reading the following detailed description given with reference to the appended drawings in which:

FIG. 1 shows the optical information storage structure according to the invention;

FIG. 2 shows a reflectivity curve and a transmission curve measured for this structure, as a function of the power of the read laser;

FIG. 3 shows two reflectivity curves measured as a function of the power of the read laser, for the InSb case and for the GaSb case respectively;

FIG. 4 shows an atomic force microscope view of a substrate in which marks with a minimum size of 80 nanometres spaced apart by a minimum of 80 nanometres have been preformed;

FIG. 5 shows curves indicating the signal/noise ratio in structures according to the invention; and

FIG. 6 shows comparative signal/noise ratio curves plotted for various dielectric substances flanking an indium antimonide layer.

### DESCRIPTION OF THE PREFERRED EMBODIMENTS

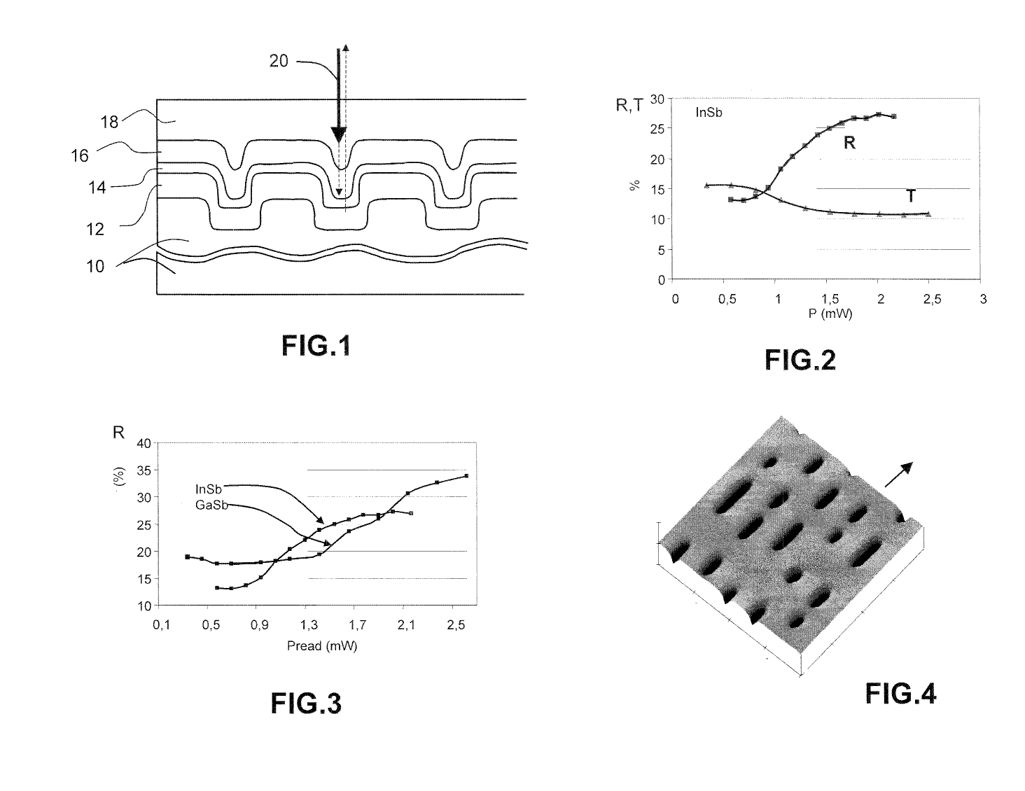

FIG. 1 shows the general structure of the optical information storage medium according to the invention. It comprises a substrate 10, which is preferably an organic material and notably polycarbonate, which is conventionally used for optical discs. The substrate will in practice be in the form of a flat disc and the information is conventionally written into the disc along approximately concentric tracks. A read laser beam, indicated by the arrow 20, placed in front of the disc, will see the information running past it as the disc rotates.

The substrate 10 includes physical marks that define the recorded information, and in this example the physical marks are made in the form of a relief impressed on the upper surface of the substrate. The relief is for example formed from pits, the width of which is roughly fixed for all the information written, but the length of which and the spacing in the run direction of the information define the content of the written information. The information is read by analysing the phase of the laser beam reflected by the structure, which phase varies at the start and at the end of the pass by each physical mark. The pits may be prerecorded by pressing the polycarbonate or the plastic substrate, for example by means of a nickel mould that has been produced using very high-resolution electron-beam etching tools.

The width, length and spacing of the physical marks may be below the theoretical optical resolution of the optical read system that will be used to read them. Typically, this is a blue laser of about 400 nanometre wavelength, used with a focusing optic whose numerical aperture is 0.85, the theoretical physical limit of resolution being around 120 nanometres when precautions are taken. Here, the marks may be prerecorded with a resolution, in terms of length or spacing, of less than 80 nanometres, as will be seen later.

In the case of a conventional optical disc, the relief would be covered with a simple aluminium layer, but this aluminium layer would not allow a blue laser to detect marks with a size and spacing of 80 nanometres.

According to the invention, the marks are covered with a triple layer consisting, in order, of a dielectric layer 12 of ZnS/SiO₂ compound, an indium antimonide (InSb) or gallium antimonide (GaSb) layer 14 and a dielectric layer 16 of ZnS/SiO₂ compound. All this is covered with a transparent protective layer 18.

The InSb or GaSb layer 14 is a layer having non-linear optical properties and it has been found that the reflectivity of the triple layer structure—GaSb or InSb layer flanked by the two ZnS/SiO₂ dielectric layers—can be very significantly increased when it is illuminated by a laser beam with a power of 1 to 2 milliwatts (corresponding in practice to a power density of about 7 milliwatts per square micron).

FIG. 2 shows by way of indication a curve of the variation in reflectivity (top curve R) and a curve of the variation in transmission (bottom curve T) of the substrate+triple layer+protective layer 18 structure as a function of the power of a 405-nanometre illumination laser. The lower ZnS/SiO₂ layer 12 has a thickness of 70 nanometres and contains about 80% ZnS for 20% SiO₂ (atomic percentages). The upper layer 16 has the same composition and a thickness of 50 nanometres. The intermediate layer is made of InSb with a thickness of 20 nanometres and a substantially stoichiometric composition. This measurement example shows that the reflectivity of the superposed structure varies greatly with the illumination power. Consequently, with a read laser of about 1.3 mW power, because of the Gaussian distribution of the beam energy the reflectivity will vary considerably between the centre of the focal spot and the periphery, hence the possibility of a very pronounced super-resolution effect.

FIG. 3 represents other measurements, namely a comparative reflectivity measurement for the structure defined in the previous paragraph and one for an identical structure in which the InSb is replaced with GaSb. The results in the case of GaSb are inferior as they require a higher read power; however, the usable power range is greater.

FIG. 4 recalls the way in which the information can be prerecorded on the substrate before deposition of the superposed three layers 12, 14, 16, namely blind holes of variable length and spacing. The arrow indicates the direction in which the substrate runs beneath the read laser.

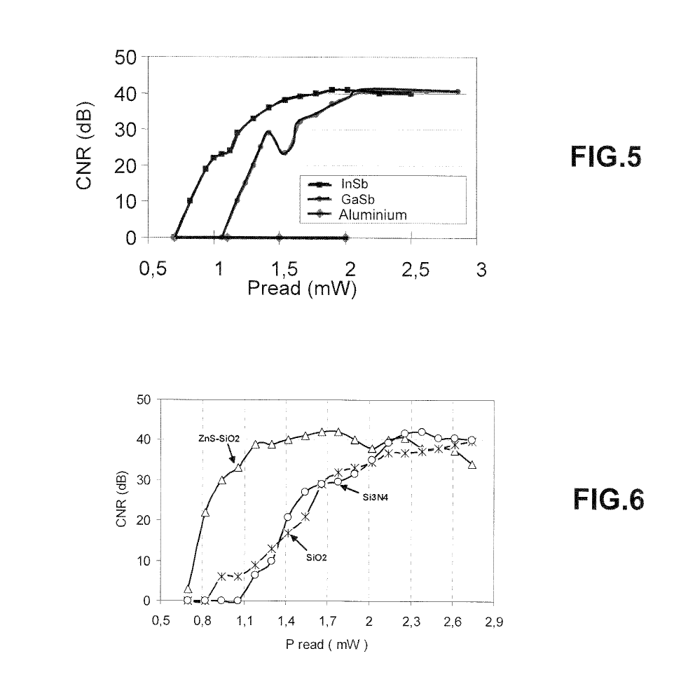

FIG. 5 shows measurements in decibels of the CNR (Carrier Noise Ratio) as a function of the power of the read laser, in the case of a substrate on which regular marks with a size of 80 nm and a spacing of 80 nm have been formed, therefore giving rise in theory to a constant frequency of the outlet signal of the laser read system. These marks are covered by the abovementioned triple layer, the 20-nanometre active layer being either InSb or GaSb. To give an indication, the CNR ratio is zero (the marks are not at all detected) if the marks are covered with 25 to 40 nanometres of aluminium (as in an ROM optical disc) rather than by the triple layer according to the invention. These curves again show that indium antimonide is more favourable than gallium antimonide from the power standpoint since the CNR is close to 35 dB for a 1.3 mW power, whereas it would instead be 2 mW for GaSb in order to obtain the same CNR.

FIG. 6 shows other comparative measurements of this CNR, on three substrate specimens with 80 nm prerecorded marks regularly spaced by 80 nm, these marks being identical in the three specimens. Only the curve on the left uses dielectric layers of ZnS/SiO₂ compound, the two curves on the right using, as dielectric, silicon oxide SiO₂ and silicon nitride Si₃N₄ respectively. The non-linear optical layer here is indium antimonide InSb. It may be seen that a much lower read power is required to achieve a high CNR in the case of the invention with ZnS/SiO₂ layers.

Finally, the read behaviour of the three structures was studied experimentally by performing multiple read operations on uniform information thus recorded, one structure being that of the invention and the others using SiO₂ or Si₃N₄ as dielectric layers. With SiO₂, it was possible to read the information with a sufficient signal/noise ratio for a power of 2.74 milliwatts but it was observed that the read signal degraded after 34 read cycles. With Si₃N₄, it was possible to read with a power of 2.26 milliwatts, but degradation was observed after 240 read cycles. However, with the ZnS/SiO₂ layers proposed according to the invention, it was possible to read with a power of 1.66 milliwatts and significant degradation of the signal was observed only after 8000 read cycles. This therefore brings out the importance of the proposed structure compared with other structures attempted, despite its unexpected character, since it is apparently based on the increase in super-resolution of the reflectivity of the structure and not on the increase in transmission, which might be considered to be more favourable than reflection knowing that physical marks lying beneath the triple layer structure have to be read.

The trials carried out have demonstrated that for a blue laser just as for a red laser, the optimum layer thicknesses of the structure according to the invention are the following:
lower ZnS/SiO₂ layer: about 50 to 70 nanometres;
GaSb or InSb layer: about 20 to 30 nanometres;
upper ZnS/SiO₂ layer: about 50 to 60 nanometres.
The preferred atomic composition for the ZnS/SiO₂ compound is about 80% ZnS for 20% SiO₂.

Deposition of the layers poses no particular problem—they may be conventionally deposited by cathode sputtering from a target comprising the materials in question, equally well in the case of the active layer as in the case of the dielectrics, or by plasma-enhanced vapour deposition.

What is claimed is:

1. High-resolution optical information storage structure, comprising a substrate provided with physical marks, the geometric configuration of which defines the information recorded, a superposition of three layers over the top of the marks on the substrate, and a transparent protective layer over the top of this superposition, the superposition comprising an indium antimonide or gallium antimonide layer inserted between two ZnS/SiO₂ dielectric layers.

2. Structure according to claim 1, wherein the atomic proportion of antimony in the antimonide layer is 45% to 55%, the indium or gallium proportion being between 45% and the balance to 100% being the antimony proportion.

3. Structure according to claim 2, wherein the antimonide layer is a stoichiometric InSb or GaSb layer.

4. Structure according to one of claims 1 to 3, wherein the thickness of the InSb or GaSb antimonide layer is between 10 and 50 nanometres.

5. Structure according to claim 4, wherein the thickness of the InSb or GaSb antimonide layer is from 20 to 30 nanometres.

6. Structure according to claim 1, wherein the ZnS/SiO₂ dielectric layers each have a thickness of between 20 and 100 nanometres.

7. Structure according to claim 6, wherein the lower ZnS/SiO₂ layer covering the marks on the substrate has a thickness of about 50 to 70 nanometres.

8. Structure according to claim 6, wherein the upper ZnS/SiO₂ layer has a thickness of about 50 to 60 nanometres.

9. Structure according to claim 1, wherein the atomic proportion of ZnS and SiO₂ is chosen in the range between ZnS_{85at %}/SiO_{2 15at %} (85/15 proportion) and ZnS_{70at %}/SiO_{2 30at %}(70/30 proportion).

10. Structure according to claim 1, wherein the substrate is made of polycarbonate.

11. Structure according to claim 1, wherein the physical marks recorded on the substrate are stamping-impressed pits.

12. An optical disc intended to be read in the super-resolution by a blue-laser reader, comprising a substrate provided with physical marks, the geometric configuration of which defines a recorded information, a superposition of three layers over the top of the marks on the substrate, and a transparent protective layer over the top of this superposition, the superposition comprising and indium antimonide or gallium antionide layer inserted between two ZnS/SiO₂ dielectric layers, some of the physical marks having a length and a width of less than 100 nanometres

13. An optical disc intended to be read in the super-resolution by a red-laser reader, comprising a substrate provided with physical marks, the geometric configuration of which defines a recorded information, a superposition of three layers over the top of the marks on the substrate and a transparent protective layer over the top of this superposition, the superposition comprising an indium antimonide or gallium antimonide layer inserted between two ZnS/SiO₂ dielectric layers, some of the physical marks having a length and a width of less than 200 nanometres.
